(19) United States
(12) Patent Application Publication
(10) Pub. No.: US 2014/0015834 A1
(43) Pub. Date: Jan. 16, 2014

(54) GRAPHICS PROCESSING UNIT, IMAGE PROCESSING APPARATUS INCLUDING GRAPHICS PROCESSING UNIT, AND IMAGE PROCESSING METHOD USING GRAPHICS PROCESSING UNIT

(71) Applicant: SAMSUNG ELECTRONICS CO., LTD., Suwon-si (KR)

(72) Inventor: Young Ihn KHO, Seoul (KR)

(21) Appl. No.: 13/937,616

(22) Filed: Jul. 9, 2013

(30) Foreign Application Priority Data
Jul. 9, 2012 (KR) 10-2012-0074741

(51) Int. Cl. G06T 11/00; G06T 15/50

(52) U.S. Cl. CPC G06T 11/001; G06T 15/506
USPC 345/426; 345/582

(57) ABSTRACT

A graphics processing unit (GPU), an image processing apparatus including the GPU, and an image processing method using the GPU are provided. The graphics processing unit includes a texture memory configured to store a plurality of two-dimensional (2D) slices formed by slicing volume data or 2D texture, a texture mapping unit configured to perform 2D texture mapping on the 2D texture and to perform 2D texture sampling on the plurality of 2D slices, and a calculation processor configured to perform volume rendering using sampling values of the 2D texture sampling.

### CROSS-REFERENCE TO RELATED APPLICATION(S)

This application claims priority from Korean Patent Application No. 10-2012-0074741, filed on Jul. 9, 2012 in the Korean Intellectual Property Office, the disclosure of which is incorporated herein by reference.

### BACKGROUND

1. Field

Apparatuses and methods consistent with exemplary embodiments relate to image processing using volume rendering for extraction and visualization of meaningful information from volume data.

2. Description of the Related Art

Volume rendering is a systematic scheme for making respective colors for pixels of a two-dimensional (2D) projection screen in order to experience a stereoscopic effect of a three-dimensional (3D) object whenever the 3D object is viewed in any direction. With regard to volume rendering, it is assumed that any object is made up of 3D voxels, how the voxels influence pixels of a screen is determined, and the determination result is considered during imaging. That is, all the voxels that influence corresponding pixels need to be considered in order to calculate color of one pixel of the 2D projection screen. Volume rendering is appropriate for modeling and visualization of membrane structures or translucent regions, which are invisible to the naked eye.

Volume rendering is broadly classified into surface rendering for expressing volume data in the form of a mesh and direct volume rendering for directly rendering without reconstruction of volume data in the form of mesh. Volume ray casting is the most popular type of direct volume rendering because it generates a high quality image.

In volume ray casting, a straight line between a viewpoint and one pixel of a display screen is referred to as a ray. In this regard, various schemes are applied to brightness intensities obtained by sampling respective points while the ray passes through volume data to generate a final image.

Sampling of any location of volume data is required to perform volume ray casting. In this case, sampling of the volume data may be more easily processed using a 3D texture mapping function supported by a commercially available graphics processing unit (GPU).

In a relatively high-performance GPU installed in a graphics card for a personal computer (PC), 3D texture mapping functions are designated according to a standard such as OpenGL and are basically supported in terms of hardware/software. However, in a relatively low-performance GPU installed in a graphics card for a mobile device, an informal version such as OpenGL ES is used, and thus, the 3D texture mapping function is often not supported. When the 3D texture mapping function is not supported by a GPU, computational load is increased during sampling of any location of volume data, and thus, rendering processing speed (image processing speed) is exceedingly reduced.

### SUMMARY

Exemplary embodiments provide a graphics processing unit (GPU), an image processing apparatus including the GPU, and an image processing method using the GPU, which may increase rendering process speed even when volume rendering using volume ray casting is performed by a GPU that does not support the 3D texture mapping function by performing sampling on volume data, which is required for the volume ray casting, using a texture mapping unit that supports a 2D texture mapping function, which is implemented in a GPU in terms of hardware, in order to perform volume rendering using volume ray casting in a GPU (e.g., a GPU installed in a graphics card for a mobile device) which does not support the 3D texture mapping function and supports only the 2D texture mapping function.

In accordance with an aspect of an exemplary embodiment, there is provided a graphics processing unit including a texture memory configured to store a plurality of two-dimensional (2D) slices formed by slicing volume data or 2D texture, a texture mapping unit configured to perform 2D texture mapping on the 2D texture and to perform 2D texture sampling on the plurality of 2D slices, and a calculation processor configured to perform volume rendering using sampling values of the 2D texture sampling.

The calculation processor may be configured to perform volume rendering using volume ray casting.

The plurality of 2D slices may be formed by slicing the volume data in parallel to any one of an XY plane, a YZ plane, and a ZX plane.

The plurality of 2D slices may be formed as one or a preset number of 2D slice atlases and is stored in the texture memory.

The calculation processor may be configured to project a virtual ray toward each pixel of a display screen from a viewpoint and calculate a position of a sample point; and the calculation processor may be configured to project the sample point onto two planes adjacent to the sample point, corresponding to two 2D slices, when the position of the sample point does not correspond to a position of a voxel of the volume data.

The calculation processor may be configured to calculate positions of two points projected onto the two planes and transmits the positions to the texture mapping unit.

The texture mapping unit may be configured to calculate brightness intensities of the two points projected onto the two planes and transmits the brightness intensities of the two points to the calculation processor.

The calculation processor may be configured to calculate brightness intensity of the sample point by linear-interpolating the brightness intensities of the two points based on distances between the sample point and the two points.

The calculation processor may be configured to accumulate brightness intensities of the sample point to calculate a pixel value displayed on each pixel of the display screen.

The calculation processor may be configured to project the virtual ray toward all pixels of the display screen to perform the volume rendering.

In accordance with an aspect of another exemplary embodiment, there is provided a graphics processing unit including a texture memory configured to store a plurality of two-dimensional (2D) slices formed by slicing volume data, a texture mapping unit configured to support a 2D texture mapping function and to perform 2D texture sampling on the plurality of 2D slices by considering the plurality of 2D slices as a 2D texture, and a calculation processor configured to perform volume rendering using volume ray casting on the plurality of 2D slices to form a 3D image, the calculation processor performing sampling of the volume rendering using a result of the 2D texture sampling.

In accordance with an aspect of another exemplary embodiment, there is provided an image processing apparatus including an image data acquisition unit configured to acquire image data, a volume data generation unit configured to generate volume data using the image data, a volume data slicing unit to slice the volume data into a plurality of two-dimensional (2D) slices, and a graphics processing unit configured to perform graphic calculation, wherein the graphics processing unit includes a texture memory configured to store the plurality of 2D slices or a 2D texture, a texture mapping unit configured to perform 2D texture mapping on the 2D texture and to perform 2D texture sampling on the plurality of 2D slices, and a calculation processor configured to perform volume rendering using sampling values of the 2D texture sampling.

The calculation processor may be configured to perform the volume rendering using volume ray casting.

The image processing apparatus may further include a display unit configured to display a 3D image generated by performing the volume rendering.

The image processing apparatus may further include a controller configured to control the graphics processing unit to perform the volume rendering on the plurality of 2D slices and to control the display unit to display the 3D image generated by performing the volume rendering on a screen.

The plurality of 2D slices may be formed as one or a preset number of 2D slice atlases and is stored in the texture memory.

In accordance with an aspect of another exemplary embodiment, there is provided an image processing apparatus including an ultrasound image data acquisition unit configured to transmit an ultrasound signal to a target object and to receive an ultrasound echo signal reflected from the target object to acquire ultrasound image data, a volume data generation unit configured to generate volume data using the ultrasound image data, a volume data slicing unit configured to slice the volume data into a plurality of 2D slices, a graphics processing unit configured to perform graphic calculation, wherein the graphics processing unit includes a texture memory configured to store the plurality of 2D slices or 2D texture, a texture mapping unit configured to perform 2D texture mapping on the 2D texture and to perform 2D texture sampling on the plurality of 2D slices, and a calculation processor configured to perform volume rendering using sampling values of the 2D texture sampling.

In accordance with an aspect of another exemplary embodiment, there is provided an image processing method using a graphics processing unit including a texture memory, a texture mapping unit configured to support a 2D texture mapping function, and a calculation processor configured to process graphic calculation, the method including storing a plurality of 2D slices formed by slicing volume data, in the texture memory, the texture mapping unit performing 2D texture sampling on the plurality of 2D slices, and the calculation process performing volume rendering using sampling values of the 2D texture sampling.

The volume rendering may be performed using volume ray casting.

### BRIEF DESCRIPTION OF THE DRAWINGS

The above and/or other aspects will become apparent and more readily appreciated from the following description of exemplary embodiments, taken in conjunction with the accompanying drawings of which:

FIG. 1 is a diagram of a structure of volume data;

FIG. 2 is a diagram explaining a concept of volume ray casting;

FIG. 3 is a diagram explaining a concept of texture mapping;

FIG. 4 is a diagram explaining a method of calculating brightness intensity of an arbitrary sample point that does not correspond to a position of a voxel in volume data during volume rendering using volume ray casting;

FIG. 5 is a diagram explaining a method of calculating brightness intensity of an arbitrary sample point that does not correspond to a position of a voxel in volume data during volume rendering with volume ray casting using a graphics processing unit (GPU), according to an exemplary embodiment;

FIG. 6 is a control block diagram of an image processing apparatus including a GPU according to an exemplary embodiment;

FIG. 7 is a block diagram of a structure of the GPU shown in FIG. 6;

FIGS. 8A and 8B are diagrams of a structure of sliced volume data (2D slices) stored in a texture memory shown in FIG. 7; and

FIG. 9 is a flowchart of an image processing method using a GPU according to an exemplary embodiment.

### DETAILED DESCRIPTION

Reference will now be made in detail to the exemplary embodiments with reference to the accompanying drawings.

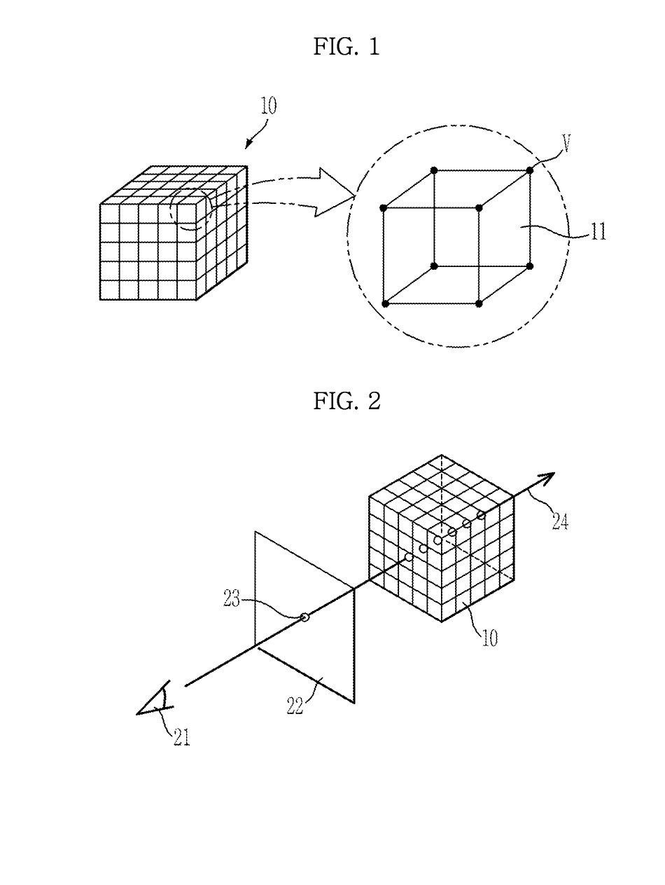

FIG. 1 is a diagram of a structure of volume data.

Volume data is used in a technology for dividing a predetermined space and surface-based data such as a polygonal mesh by which a surface of a three-dimensional (3D) object is expressed into lattices (space lattices) and representing vertexes (voxels) of each lattice as corresponding values (positions, colors, and brightness), is extensively used in medicine or scientific calculation fields, and is often used to express fog in a game, a special effect, or the like.

As shown in FIG. 1, volume data 10 may be represented by voxels V, and a cube structure including 8 voxels V is referred to as a cell 11. Among cells 11, a cell of which all 8 voxels V are transparent is referred to as a transparent cell and a cell of which all 8 voxels V are nontransparent is referred to as a nontransparent cell. In addition, a cell in which transparent and nontransparent voxels are present together among 8 voxels is referred to as a semi-transparent cell.

FIG. 2 is a diagram explaining a concept of volume ray casting.

A volume rendering scheme is a process of displaying 3D volume data 10 on a 2D display screen. Among volume rending schemes, volume ray casting is most often used in general because an excellent result image is obtained.

As shown in FIG. 2, in the volume ray casting, it is assumed that a ray 24 projected toward each pixel 23 of a display screen 22 from a viewpoint 21 proceeds toward the volume data 10 through the pixel 23, and a plurality of brightness intensities obtained by sampling respective points while the ray 24 passes through the volume data 10 are accumulated to calculate a final color value to be displayed on the pixel 23 of the display screen 22 through which the ray 24 passes. In this case, the ray 24 is projected once per pixel of the display screen 22, and thus, the ray 24 is projected the same number of times as the total number of pixels of the display screen 22 during volume rendering.

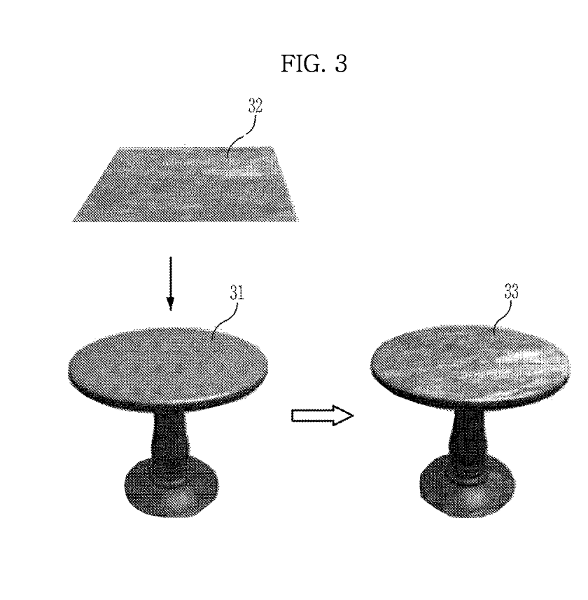

FIG. 3 is a diagram explaining a concept of texture mapping.

Texture mapping refers to a process of patterning or coloring a surface of an image or object to be expressed in order to realistically express the image or the object. FIG. 3 shows an example of 2D texture mapping for expressing a table 33 with a detailed texture by applying a 2D texture 32 to a surface of a table 31. In the texture mapping, a 3D texture as well as a 2D texture may be used. The 3D texture mapping is different from the 2D texture mapping only in that a type of texture used during mapping is a 3D image with a volume, not a 2D planar image.

Texture sampling is required for the texture mapping and refers to calculation of brightness intensity of an arbitrary location in a texture, which is a function required to map a texture with a limited resolution to a surface with an arbitrary size. The texture sampling is a function that is very often used in 3D graphics, and thus, is implemented in terms of hardware and is processed at high speed in a graphics processing unit (GPU).

As described above, in order to perform volume rendering using volume ray casting, sampling needs to be performed on volume data. A sampling process of searching for an appropriate voxel in the volume data takes a very long time, and thus, improvement in the speed of the sampling process is an important design objective.

By virtue of a 3D texture mapping function of graphics hardware, linear interpolation or tri-linear interpolation may be processed at very high speed in terms of hardware. Thus, sampling of volume data, which is required for volume rendering using volume ray casting, may be more easily processed using a 3D texture sampling function performed during the 3D texture mapping. In volume rendering using the 3D texture mapping, volume data is considered as a 3D texture, and sampling is processed at very high speed via hardware texture mapping. That is, when the volume data is considered as a 3D texture and is stored in a texture memory, and brightness intensity of a desired location (a location of a sample point based on a set interval) is requested, a texture mapping unit provides a desired value via 3D texture sampling.

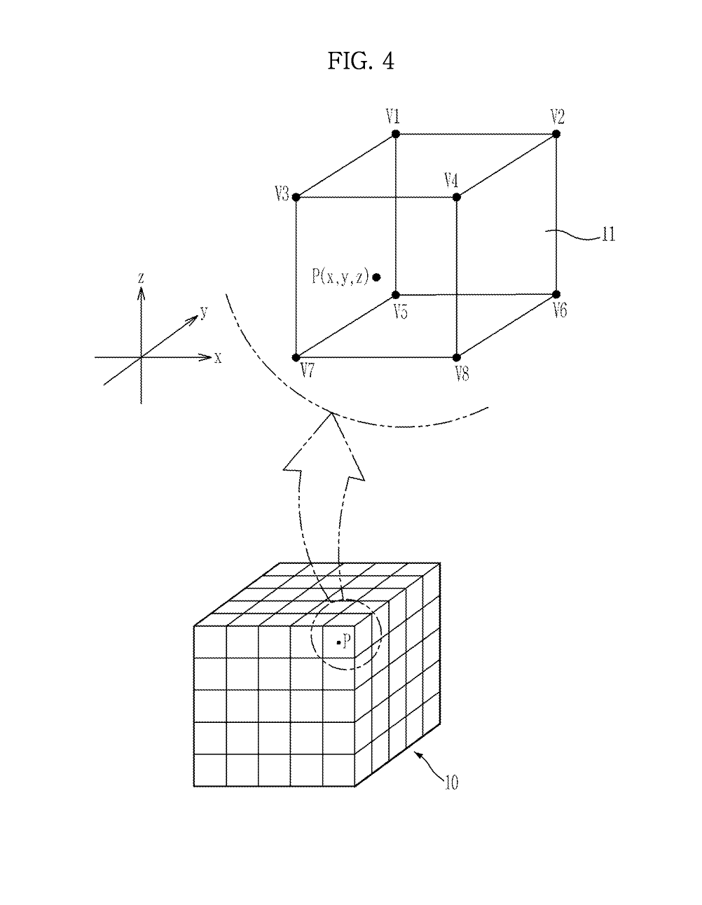

FIG. 4 is a diagram explaining a method of calculating brightness intensity of an arbitrary sample point that does not correspond to a position of a voxel in volume data during volume rendering using volume ray casting.

As described above, in a relatively high-performance GPU installed in a graphics card for a personal computer (PC), a 3D texture mapping function is basically supported in terms of hardware/software. However, in a relatively low-performance GPU installed in a graphics card for a mobile device, a 3D texture mapping function is often not supported. In this case, a position of a sample point P to be sampled in volume data is assumed to be P(x, y, z). As shown in FIG. 4, when the 3D texture mapping function is not supported by a GPU, it is necessary to read brightness intensities at positions of 8 voxels V1 to V8 adjacent to an arbitrary sample point P from a memory in which the volume data 10 is stored and to interpolate the brightness intensities in terms of software in order to calculate brightness intensity of the sample point P that does not correspond to a position of the voxel V in the volume data 10. However, when sampling is performed at an arbitrary position in the volume data 10 using such a software method, a computational load is increased, thereby reducing rendering processing speed.

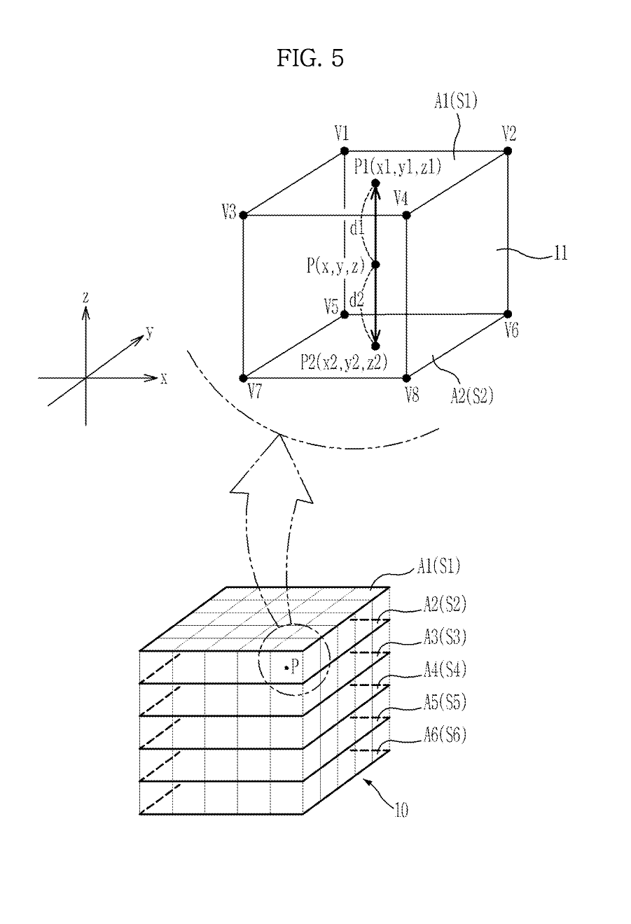

FIG. 5 is a diagram explaining a method of calculating brightness intensity of an arbitrary sample point that does not correspond to a position of a voxel in volume data during volume rendering with volume ray casting using a GPU, according to an exemplary embodiment.

As described above, when sampling is performed on volume data using a software method on a platform (e.g., a mobile device) which does not support a 3D texture mapping function, a computational load is increased, thereby reducing rendering process speed. An exemplary embodiment proposes a method of increasing rendering process speed even when volume rendering using volume ray casting is performed by a GPU that does not support the 3D texture mapping function by sampling on volume data, which is required for the volume ray casting, using a texture mapping unit that supports the 2D texture mapping function, which is implemented in a GPU in terms of hardware, in order to perform the volume rendering using the volume ray casting in a GPU (e.g., a GPU installed in a graphics card for a mobile device) which does not support the 3D texture mapping function and supports only a 2D texture mapping function.

According to the present exemplary embodiment, it is assumed that a position of an arbitrary sample point P that does not correspond to a position of the voxel V in the volume data 10 is P(x, y, z) and the volume data 10 is made up of a plurality of 2D slices that are arranged in parallel to an XY plane. FIG. 5 shows a case in which the volume data 10 includes six 2D slices S1, S2, S3, S4, S5, and S6. Here, the 2D slices S1 to S6 refer to volume data that is two-dimensionally divided, not a coordinate plane. In addition, the 2D slices S1 to S6 may refer to a data structure of brightness intensities at positions of the voxels V in the volume data 10, which are contained in each of the 2D slices S1 to S6. In this case, planes A1, A2, A3, A4, A5, and A6 shown in FIG. 5 correspond to the 2D slices S1 to S6, respectively.

In order to calculate brightness intensity of an arbitrary sample point P to be sampled, the sample point P is projected onto a plane A1 corresponding to the 2D slice S1 that is upward closest to the sample point P and a plane A2 corresponding to the 2D slice S2 that is downward closest to the sample point P. In this case, a point that is projected onto the plane A1 corresponding to the 2D slice S1 that is upward closest to the sample point P is referred to as a point P1 and a point that is projected onto a plane A2 corresponding to the 2D slice S2 that is downward closest to the sample point P is referred to as a point P2. In this case, a position of the point P1 is P1 (x1, y1, z1) and a position of the point P2 is P2(x2, y2, z2). Then, brightness intensities at positions of four voxels V1 to V4 adjacent to the point P1 that is positioned on the plane A1 corresponding to the 2D slice S1 and is projected are read from a memory that stores the 2D slice S1, and are interpolated in terms of hardware using a texture mapping unit that supports a 2D texture mapping function. In addition, brightness intensities at positions of four voxels V5 to V8 adjacent to the point P2 that is positioned on the plane A2 corresponding to the 2D slice S2 and is projected are read from a memory that stores the 2D slice S2, and are interpolated performed in terms of hardware using the texture mapping unit that supports the 2D texture mapping function. Then, when brightness intensity at a position of the point P1, which is calculated by interpolating the brightness intensities at the positions of the four voxels V1 to V4 positioned on the plane A1, is referred to as a1, and brightness intensity at a position of the point P2, which is calculated by interpolating the brightness intensities at the positions of the four voxels V5 to V8 positioned on the plane A2, is referred to as a2, brightness intensity a of the sample point P may be calculated by linear-interpolating the brightness intensities a1 and a2 based on a distance d1 between the sample point P and the point P1 and a distance d2 between the sample point P and the point P2 according to Expression 1 below.

a=(d1*a2+d2*a1)/(d1+d2) [Expression 1]

According to the present exemplary embodiment, a process of calculating the brightness intensity a1 at the point P1 projected onto the plane A1 corresponding to the 2D slice S1 by interpolating the brightness intensities at the four voxels V1 to V4 adjacent to the point P1 positioned on the plane A1 and a process of calculating the brightness intensity a2 at the point P2 projected onto the plane A2 corresponding to the 2D slice S2 by interpolating the brightness intensities at the four voxels V5 to V8 adjacent to the point P2 positioned on the plane A2 may be accelerated by hardware (in this case, a texture mapping unit supporting a 2D texture mapping function), and thus, sampling may be processed at very high speed, thereby improving overall rendering performance.

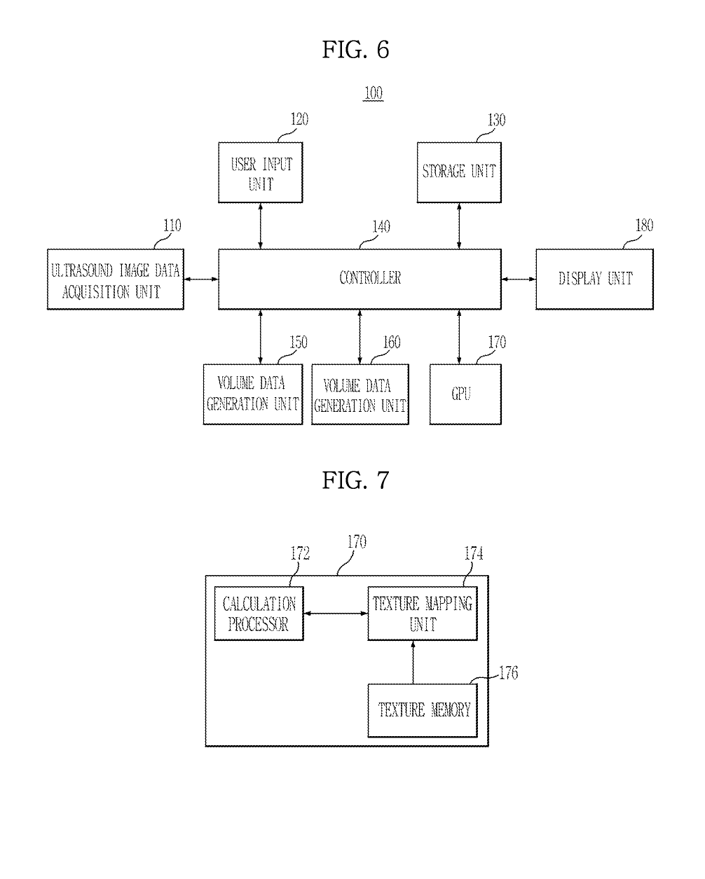

FIG. 6 is a control block diagram of an image processing apparatus including a GPU according to an exemplary embodiment. According to the present exemplary embodiment, an ultrasound image processing apparatus 100 used in ultrasonography will be exemplified as the image processing apparatus including the GPU.

According to the present exemplary embodiment, as shown in FIG. 6, the ultrasound image processing apparatus 100 that is an example of the image processing apparatus including the GPU includes an ultrasound image data acquisition unit 110, a user input unit 120, a storage unit 130, a controller 140, a volume data generation unit 150, a volume data slicing unit 160, a GPU 170, and a display unit 180.

The ultrasound image data acquisition unit 110 transmits an ultrasound signal to a target object and receives an ultrasound signal (that is, an ultrasound echo signal) reflected from the target object to acquire ultrasound image data.

The user input unit 120 may receive, from a user, a plurality of rendering setting information such as a sampling interval of the volume data 10 and a ray projection direction (a ray casting direction) toward the volume data 10, which are required for rendering using volume ray casting, region of interest (ROI) setting information such as information on the position and size of an ROI, and the like, and may include an input device such as a control panel, a mouse, a keyboard, or the like. In addition, the user input unit 120 may include a display unit in order to input information or may be integrated with the display unit 180 that will be described below.

The storage unit 130 stores the plurality of rendering setting information and the ROI setting information, which are input through the user input unit 120, information regarding a 3D ultrasound image (a rendering result image) formed by the GPU 170, and the like.

The controller 140 is a central processing unit (CPU) for controlling an overall operation of the ultrasound image processing apparatus 100. When the rendering setting information and the ROI setting information are input to the controller 140 from the user input unit 120, the controller 140 transmits a control signal to the GPU 170 and controls the GPU 170 to perform rendering (i.e., volume rendering using volume ray casting) on volume data based on the rendering setting information and the ROI setting information. In addition, the controller 140 transmits a control signal to the display unit 180 and controls the display unit 180 to display a 3D ultrasound image that is formed by the GPU 170 and is stored in the storage unit 130. In addition, the controller 140 controls transmission and reception of ultrasound signals, generation of volume data, and slicing of volume data.

The controller 140 of the ultrasound image processing apparatus 100 controls only data input and output of the ultrasound image data acquisition unit 110, the volume data generation unit 150, the volume data slicing unit 160, the GPU 170, and the display unit 180 during an image processing process, thereby remarkably reducing load of the controller 140.

The volume data generation unit 150 generates the 3D volume data 10 made up of a plurality of voxels, which indicate brightness intensities, using a plurality of ultrasound image data provided from the ultrasound image data acquisition unit 110.

The volume data slicing unit 160 slices the 3D volume data 10 into a plurality of 2D slices S1 to S6. In this case, the volume data slicing unit 160 may slice the volume data 10 in parallel to an XY plane, a YZ plane, or a ZX plane to form the plurality of 2D slices S1 to S6.

The GPU 170 is a graphics chipset for graphic calculation and performs volume rendering on the sliced volume data, that is, the plurality of 2D slices S1 to S6 to calculate final pixel data to be displayed on a pixel of a display screen. Here, the GPU 170 performs the volume rendering on the plurality of 2D slices S1 to S6 using volume ray casting that is a representative method among direct volume rendering methods. A structure and function of the GPU 170 will be described in detail with reference to FIG. 7.

The display unit 180 is implemented as a monitor or the like and displays a 3D ultrasound image rendered by the GPU 170.

According to the present exemplary embodiment, the ultrasound image processing apparatus 100 has been exemplified as an image processing apparatus including a GPU, but the technical idea of exemplary embodiments may be applied to any field using 3D rendering of volume data as well as to an ultrasound image processing apparatus. For example, of course, the technical idea of exemplary embodiments may also be applied to an image processing apparatus used in medical imaging such as a computed tomography (CT) apparatus, a magnetic resonance imaging (MRI) apparatus, and the like. Here, when the image processing apparatus including the GPU is a CT apparatus, volume data is generated using CT image data. When the image processing apparatus including the GPU is an MRI apparatus, volume data is generated using MRI image data.

In addition, the technical idea of exemplary embodiments may also be applied to an image processing apparatus (e.g., a personal computer (PC)) of entertainment fields such as a game using a special effect such as a fog effect, as well as an image processing apparatus used in medical imaging such as an ultrasonography apparatus, a CT apparatus, and an MRI apparatus. Here, when the image processing apparatus including the GPU is an image processing apparatus used in a game field, the ultrasound image data acquisition unit 110 may be omitted among the elements shown in FIG. 6. As necessary, the volume data generation unit 150 and the volume data slicing unit 160 may be omitted (assuming that the sliced volume data is stored in a graphic memory of a GPU in advance, which will be described below).

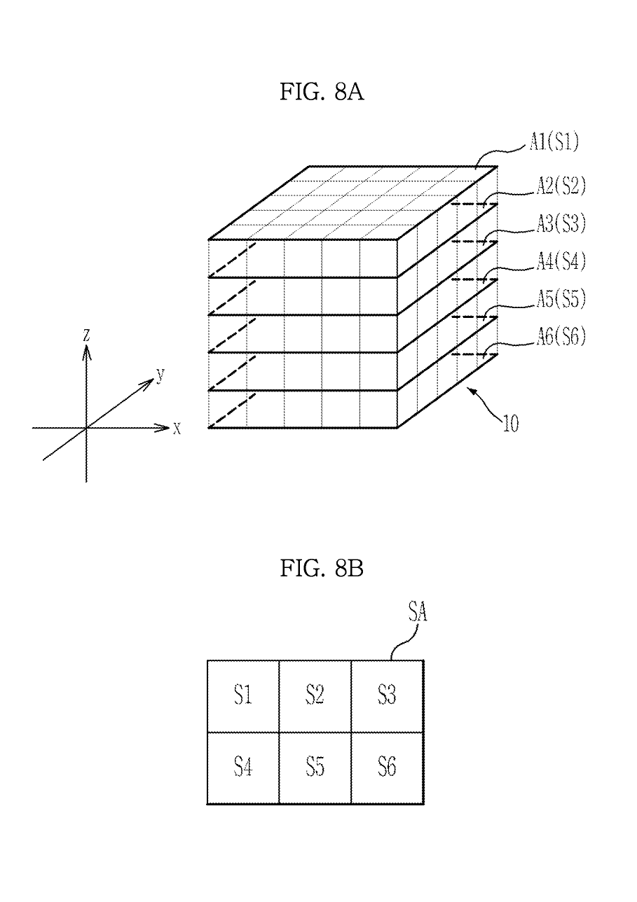

FIG. 7 is a block diagram of a structure of the GPU 170 shown in FIG. 6, and FIGS. 8A and 8B are diagrams of a structure of sliced volume data (2D slices) stored in a texture memory 176 shown in FIG. 7.

As shown in FIG. 7, according to the present exemplary embodiment, the GPU 170 includes a calculation processor 172, a texture mapping unit 174, and the texture memory 176.

The calculation processor 172 forms a 3D image by performing volume rendering using volume ray casting on volume data, in more detail, volume data (that is, 2D slices) sliced by the volume data slicing unit 160 according to a user command from the user input unit 120. Here, the calculation processor 172 receives only position (coordinate) information of volume data generated by the volume data generation unit 150, and brightness information at positions of the voxels V in the volume data is stored in the texture memory 176 in the form of 2D slice.

Thus, the calculation processor 172 may not perform rendering on voxels generated by the volume data generation unit 150 directly using 3D volume data containing position, color, and brightness information corresponding to the respective voxels, and may instead perform only relatively simple calculation required for a volume rendering process using only the position (coordinate) information of the volume data.

When the rendering setting information is input to the calculation processor 172 from the user input unit 120, the calculation processor 172 sets a ray projection start time and ray scanning direction for performing rendering using volume ray casting at the position (coordinate) of the volume data, and calculates positions of points to be sampled using the position (coordinate) information of the volume data.

In addition, when the ROI setting information is input to the calculation processor 172 from the user input unit 120, the calculation processor 172 sets an ROI of the position (coordinate) of the volume data according to the ROI setting information, and performs rendering on the ROI to form a 3D image corresponding to the ROI.

In order to calculate brightness intensity of an arbitrary sample point P to be sampled during the rendering using the volume ray casting, that is, in order to perform sampling, the calculation processor 172 calculates the position (x, y, z) of the sample point P according to the sampling interval information input through the user input unit 120. In this case, it is assumed that the volume data 10 is divided in to the plurality of 2D slices S1 to S6 that are arranged in parallel to the XY plane, by the volume data slicing unit 160, and is stored in the texture memory 176. When the calculation processor 172 determines that a position of the calculated sample point P does not correspond to a position of the voxel V in the volume data 10, the calculation processor 172 projects the sample point P onto the plane A1 corresponding to the 2D slice S1 that is upward closest to the sample point P and the plane A2 corresponding to the 2D slice S2 that is downward closest to the sample point P. The calculation processor 172 calculates a position (coordinate) of the point P1 projected onto the plane A1 and a position (coordinate) of the point P2 projected onto the plane A2 and provides information regarding the positions (coordinates) of the calculated points P1 and P2 to the texture mapping unit 174. The texture mapping unit 174 supporting a 2D texture mapping function calculates brightness intensities at positions of the points P1 and P2 with reference to brightness intensities at positions of voxels in 2D slices, stored in the texture memory 176.

The calculation processor 172 receives the brightness intensity a1 at the position of the point P1 and the brightness intensity a2 at the position of the point P2, which are calculated by the texture mapping unit 174, and calculates the brightness intensity a of the sample point P in terms of software by linear-interpolating the brightness intensities a1 and a2 based on a distance d1 between the sample point P and the point P1 and a distance d2 between the sample point P and the point P2 according to Expression 1 below.

a=(d1*a2+d2*a1)/(d1+d2) [Expression 1]

The calculation processor 172 accumulates brightness intensities of the calculated sample points P to calculate a final color value (pixel value) to be displayed on a pixel of a display screen, through which a ray passes. When ray projection, sampling, and accumulation are completed on all the pixels of the display screen, the calculation processor 172 generates a final 3D image using calculated pixel values and transmits a rendering result image to the controller 140.

The texture mapping unit 174 performs texture mapping for applying texture to each polygon constituting a surface of a 3D object. Here, the texture mapping unit 174 supports a 2D texture mapping function for mapping a 2D texture to the surface of the 3D object and is implemented in the GPU 170 in terms of hardware.

When the texture mapping is performed, texture sampling for calculating brightness intensity at an arbitrary position in a texture is required, and linear interpolation or tri-linear interpolation is used in the texture sampling. By virtue of a 2D texture mapping function of the texture mapping unit 174 that is graphics hardware, linear interpolation or tri-linear interpolation may be processed at very high speed in terms of hardware. Here, in volume rendering using the 2D texture mapping function, volume data is sliced into a plurality of 2D slices, the 2D slices (the sliced volume data) are considered as a 2D texture, and hardware texture mapping is performed on the 2D slices. Thus, sampling may be very quickly processed during the volume rendering.

When position information of the points P1 and P2 obtained by projecting the sample point P to planes corresponding to 2D slices is provided to the texture mapping unit 174 from the calculation processor 172, the texture mapping unit 174 calculates brightness intensities of the positions of the points P1 and P2 using the position information of the points P1 and P2 and a mapping formula.

That is, the texture mapping unit 174 reads brightness intensities at positions of the four voxels V1 to V4 adjacent to the point P1 from the texture memory 176, which stores the 2D slice S1, using position information (x1, y1, z1) of the point P1 and the mapping formula and interpolates the brightness intensities to calculate brightness intensity at a position of the point P1. In addition, the texture mapping unit 174 reads brightness intensities at positions of the four voxels V5 to V8 adjacent to the point P2 from the texture memory 176, which stores the 2D slice S2, using position information (x2, y2, z2) of the point P2 and the mapping formula and interpolates the brightness intensities to calculate brightness intensity at a position of the point P2.

The texture mapping unit 174 calculates the brightness intensities of the points P1 and P2 projected onto planes corresponding to the 2D slices S1 and S2 using a 2D texture mapping function implemented in terms of hardware, and then, provides the calculated brightness intensities of the points P1 and P2 to the calculation processor 172.

The texture memory 176 stores the plurality of 2D slices S1 to S6 formed by slicing the volume data 10 or 2D texture required for 2D texture mapping.

In general, in order to perform volume rendering with volume ray casting using a GPU, entire volume data needs to be stored in a texture memory of the GPU. When the GPU supports a 3D texture function, volume data to be rendered may be stored in a 3D texture memory. However, as in the present exemplary embodiment, when the GPU does not support the 3D texture mapping function and supports only the 2D texture mapping function, only a 2D texture memory may be used. Thus, volume data to be rendered may not be stored directly in the 2D texture memory, and 3D volume data may be sliced into 2D slices and then may be stored in the 2D texture memory.

Here, when the 2D slices S1 to S6 are each stored in one texture memory 176, a shader of the GPU 170 may not perform dynamic indexing of arrangement of the texture memory 176, and thus, branching statements are required as many as the number of the 2D slices S1 to S6 every sampling, thereby increasing a programming code length and increasing a computational load. Thus, according to the present exemplary embodiment, the plurality of 2D slices S1 to S6 is formed as a predetermined number (e.g., 2 to 3) of 2D slice atlases and is stored in one or a predetermined number (e.g., 2 to 3) of texture memories 176. In this case, it may be possible to easily obtain desired 2D slices S1 to S6 using the mapping formula without dynamic indexing.

For example, as shown in FIG. 8A, when the volume data 10 is sliced into the 6 2D slices S1 to S6, the 6 2D slices S1 to S6 are formed as one 2D slice atlas SA and are stored in one texture memory 176, as shown in FIG. 8B. Here, as shown in FIG. 8A, each of the planes A1, A2, A3, A4, A5, and A6 respectively corresponding to the 2D slices S1 to S6 has 36 (6*6=36) voxels V, each of the 2D slices S1 to S6 stored in the texture memory 176 may have brightness intensities at positions of the 36 voxels V.

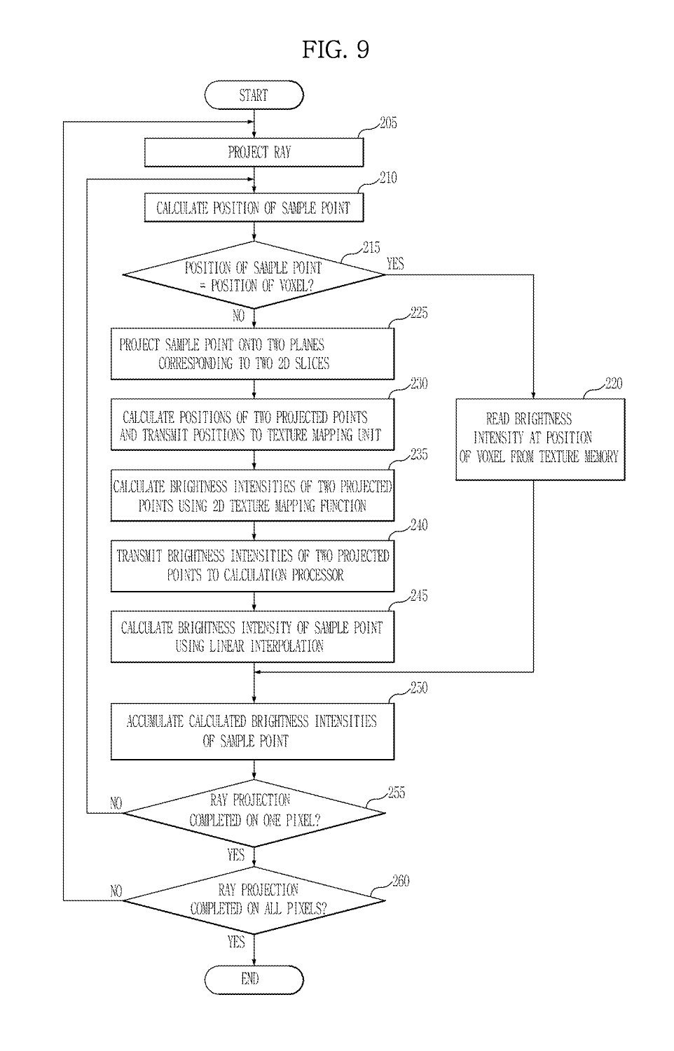

FIG. 9 is a flowchart of an image processing method using a GPU according to an exemplary embodiment.

As an initial condition for description of operations according to the present exemplary embodiment, it is assumed that rendering is performed on the volume data 10 using volume ray casting and that the texture memory 176 in the GPU 170 stores the plurality of 2D slices S1 to S6 formed by slicing the volume data 10 which is subjected to volume rendering.

First, the calculation processor 172 of the GPU 170 projects the virtual ray 24 toward each pixel 23 of the display screen 22 from the viewpoint 21 (205).

Then, the calculation processor 172 calculates a position of the sample point P according to preset sampling interval information in order to perform sampling on the volume data 10 (210).

Then, the calculation processor 172 determines whether or not the calculated position of the sample point P corresponds to a position of each of the voxels V of the volume data 10 (215). When it is determined that the calculated position of the sample point P corresponds to the position of each of the voxels V of the volume data 10 (‘YES’ of operation 215), the calculation processor 172 reads brightness intensities at positions of the voxels V from the texture memory 176 (220), and then, operation 250 is performed.

When it is determined that the calculated position of the sample point P does not correspond to the position of each of the voxels V of the volume data 10 (‘NO’ of operation 215), the calculation processor 172 projects the sample point P onto two planes adjacent to the sample point P, corresponding to two slices (225). For example, when the volume data 10 is divided into the plurality of 2D slices S1 to S6 positioned in parallel to an XY plane and is stored in the texture memory 176, the calculation processor 172 projects the sample point P onto the plane A1 corresponding to the 2D slice S1 that is upward closest to the sample point P and the plane A2 corresponding to the 2D slice S2 that is downward closest to the sample point P. Here, a point that is projected onto the plane A1 is referred to as a point P1 and a point that it projected onto a plane A2 is referred to as a point P2.

Then, the calculation processor 172 calculates positions of the points P1 and P2 projected onto the planes A1 and A2 corresponding to the 2D slices S1 and S2 and transmits the positions to the texture mapping unit 174 (230).

Then, the texture mapping unit 174 calculates the brightness intensities a1 and a2 of the two projected points P1 and P2 using a 2D texture mapping function (235).

Then, the texture mapping unit 174 transmits the brightness intensities a1 and a2 of the two projected points P1 and P2 to the calculation processor 172 (240).

Then, the calculation processor 172 calculates the brightness intensity a of the sample point P by linear-interpolating the brightness intensities a1 and a2 of the two projected points P1 and P2 based on the distance d1 between the sample point P and the point P1 and the distance d2 between the sample point P and the point P2 (245).

Then, the calculation processor 172 accumulates calculated brightness intensities a of the sample point P (250).

Then, the calculation processor 172 determines whether ray projection (including a sampling process) is completed on one pixel of the display screen 22 (255). When it is determined that the ray projection is not completed on one pixel of the display screen 22 (‘NO’ of operation 255), the calculation processor 172 returns to operation 210, and then, calculates a position of the sample point P.

When it is determined that the ray projection is completed on one pixel of the display screen 22 (‘YES’ of operation 255), the calculation processor 172 re-determines whether or not ray projection (including a sampling process) is completed on all pixels of the display screen 22 (260). When it is determined that the ray projection is not completed on the all pixels of the display screen 22 (‘NO’ of operation 260), the calculation processor 172 returns to operation 205 and projects the virtual ray 24 toward a next pixel of the display screen 22 from the viewpoint 21.

When it is determined that the ray projection is completed on the all pixels of the display screen 22 (‘YES’ of operation 260), the calculation processor 172 completes rendering on the volume data 10.

As is apparent from the above description, according to the suggested GPU, an image processing apparatus including the GPU, and an image processing method using the GPU, rendering process speed may be increased even when volume rendering using volume ray casting is performed by a GPU that does not support the 3D texture mapping function by performing sampling on volume data, which is required for the volume ray casting, using a texture mapping unit that supports a 2D texture mapping function, which is implemented in a GPU in terms of hardware in order to perform the volume rendering using the volume ray casting in a GPU (e.g., a GPU installed in a graphics card for a mobile device) which does not support the 3D texture mapping function and supports only the 2D texture mapping function.

Although a few exemplary embodiments have been shown and described, it would be appreciated by those skilled in the art that changes may be made in these exemplary embodiments without departing from the principles and spirit of the invention, the scope of which is defined in the claims and their equivalents.

What is claimed is:

1. A graphics processing unit comprising:
a texture memory configured to store a plurality of two-dimensional (2D) slices formed by slicing volume data or 2D texture;
a texture mapping unit configured to perform 2D texture mapping on the 2D texture and to perform 2D texture sampling on the plurality of 2D slices; and
a calculation processor configured to perform volume rendering using sampling values of the 2D texture sampling.

2. The graphics processing unit according to claim 1, wherein the calculation processor is configured to perform the volume rendering using volume ray casting.

3. The graphics processing unit according to claim 2, wherein the plurality of 2D slices is formed by slicing the volume data in parallel to one of an XY plane, a YZ plane, and a ZX plane.

4. The graphics processing unit according to claim 3, wherein the plurality of 2D slices is formed as one or a preset number of 2D slice atlases and is stored in the texture memory.

5. The graphics processing unit according to claim 3, wherein:
the calculation processor is configured to project a virtual ray toward each pixel of a display screen from a viewpoint and calculate a position of a sample point; and
the calculation processor is configured to project the sample point onto two planes adjacent to the sample point, corresponding to two 2D slices, when the position of the sample point does not correspond to a position of a voxel of the volume data.

6. The graphics processing unit according to claim 5, wherein the calculation processor is configured to calculate positions of two points projected onto the two planes and provide the positions to the texture mapping unit.

7. The graphics processing unit according to claim 6, wherein the texture mapping unit is configured to calculate brightness intensities of the two points projected onto the two planes and provide the brightness intensities of the two points to the calculation processor.

8. The graphics processing unit according to claim 7, wherein the calculation processor is configured to calculate brightness intensity of the sample point by linear-interpolating the brightness intensities of the two points based on distances between the sample point and the two points.

9. The graphics processing unit according to claim 8, wherein the calculation processor is configured to accumulate brightness intensities of the sample point to calculate a pixel value displayed on each pixel of the display screen.

10. The graphics processing unit according to claim 9, wherein the calculation processor is configured to project the virtual ray toward all pixels of the display screen to perform the volume rendering.

11. A graphics processing unit comprising:
a texture memory configured to store a plurality of two-dimensional (2D) slices formed by slicing volume data;
a texture mapping unit configured to support a 2D texture mapping function and to perform 2D texture sampling on the plurality of 2D slices by considering the plurality of 2D slices as a 2D texture; and
a calculation processor configured to perform volume rendering using volume ray casting on the plurality of 2D slices to form a 3D image, and perform sampling of the volume rendering using a result of the 2D texture sampling.

12. An image processing apparatus comprising:
an image data acquisition unit configured to acquire image data;
a volume data generation unit configured to generate volume data using the image data acquired by the image data acquisition unit;
a volume data slicing unit configured to slice the volume data into a plurality of two-dimensional (2D) slices; and
a graphics processing unit configured to perform graphic calculation,
wherein the graphics processing unit comprises:
a texture memory configured to store the plurality of 2D slices or a 2D texture;
a texture mapping unit configured to perform 2D texture mapping on the 2D texture and to perform 2D texture sampling on the plurality of 2D slices; and
a calculation processor configured to perform volume rendering using sampling values of the 2D texture sampling.

13. The image processing apparatus according to claim 12, wherein the calculation processor is configured to perform the volume rendering using volume ray casting.

14. The image processing apparatus according to claim 12, further comprising a display unit configured to display a 3D image generated by the volume rendering performed by the calculation processor.

15. The image processing apparatus according to claim 14, further comprising a controller configured to control the graphics processing unit to perform the volume rendering on the plurality of 2D slices and to control the display unit to display the 3D image on a screen.

16. The image processing apparatus according to claim 12, wherein the plurality of 2D slices is formed as one or a preset number of 2D slice atlases and is stored in the texture memory.

17. An image processing apparatus comprising:
an ultrasound image data acquisition unit configured to transmit an ultrasound signal to a target object and to receive an ultrasound echo signal reflected from the target object to acquire ultrasound image data;
a volume data generation unit configured to generate volume data using the ultrasound image data;
a volume data slicing unit configured to slice the volume data into a plurality of two-dimensional (2D) slices; and
a graphics processing unit configured to perform graphic calculation,
wherein the graphics processing unit comprises:
a texture memory configured to store the plurality of 2D slices or 2D texture;
a texture mapping unit configured to perform 2D texture mapping on the 2D texture and to perform 2D texture sampling on the plurality of 2D slices; and
a calculation processor configured to perform volume rendering using sampling values of the 2D texture sampling.

18. An image processing method using a graphics processing unit comprising a texture memory, a texture mapping unit configured to support a two-dimensional (2D) texture mapping function, and a calculation processor configured to process graphic calculation, the image processing method comprising:
storing a plurality of 2D slices formed by slicing volume data, in the texture memory;
performing, by the texture mapping unit, 2D texture sampling on the plurality of 2D slices; and
performing, by the calculation processor, volume rendering using sampling values of the 2D texture sampling.

19. The image processing method according to claim 18, wherein the volume rendering is performed using volume ray casting.
